(19) United States
(12) Patent Application Publication
(10) Pub. No.: US 2023/0215152 A1
(43) Pub. Date: Jul. 6, 2023

(54) LEARNING DEVICE, TRAINED MODEL GENERATION METHOD, AND RECORDING MEDIUM

(71) Applicant: NEC Corporation, Minato-ku, Tokyo (JP)

(72) Inventors: Tomokazu Kaneko, Tokyo (JP); Makoto Terao, Tokyo (JP)

(73) Assignee: NEC Corporation, Minato-ku, Tokyo (JP)

(21) Appl. No.: 18/007,569

(22) PCT Filed: Jun. 3, 2020
(86) PCT No.: PCT/JP2020/021875

§ 371 Date: Dec. 1, 2022

(51) Int. Cl. G06V 10/776; G06V 10/77; G06V 10/764

(52) U.S. Cl. CPC G06V 10/776; G06V 10/764; G06V 10/7715

(57) ABSTRACT

In a learning device, a feature extraction means extracts image features from an input image. A class discrimination means discriminate a class of the input image based on the image features, and generates a class discriminative result. A class discriminative loss calculation means calculates a class discriminative loss based on the class discriminative result. A normal/abnormal discrimination means discriminates whether the class is a normal class or an abnormal class, based on the image features, and generates a normal/abnormal discriminative result. The AUC loss calculation means calculates an AUC loss based on the normal/abnormal result. A first learning means updates parameters of the feature extraction means, a class discrimination means, and the normal/abnormal discrimination means, based on the class discriminative loss and the AUC loss.

### TECHNICAL FIELD

The present disclosure relates to an image discrimination technique using a domain adaptation.

### BACKGROUND ART

In an image recognition or the like, a technique to train a discriminator using a domain adaptation is known in a case where training data cannot be obtained sufficiently in a target area. The domain adaptation is a technique to train the discriminator of a diversion destination (target domain) using the training data of a diversion source (source domain). A method for training the discriminator using the domain adaptation is described in Patent Document 1 and Non-Patent Document 1.

### PRECEDING TECHNICAL REFERENCES

### Patent Document

Patent Document 1: Japanese Laid-open Patent Publication No. 2016-224821

Non-Patent Document 1: Yaroslav Ganin, Evgeniya Ustinova, Hana Ajakan, Pascal Germain, Hugo Larochelle, Francois Laviolette, Mario Marchand, and Victor Lempitsky, “Domain-adversarial training of neural networks”, J. Mach. Learn. Res. 17, 1 (January 2016), 2096-2030.

### SUMMARY

### Problem to Be Solved by the Invention

The technique described in the above literature and the like assumes that, as a source domain, a data set in which training data such as a public data set or the like are collected satisfactorily and evenly is used. However, in practice, the training data may not be prepared satisfactorily and evenly for all classes to be discriminated. In particular, for classes classified into predetermined abnormal class, it may be difficult to collect images themselves. In a case where there are fewer sets of training data for the abnormal class, even if training is performed using the domain adaptation, the training of the discriminator will be concentrated in a normal class, and the discriminator obtained by the training will not be able to correctly discriminate the abnormal class.

It is one object of the present disclosure to provide a learning device capable of generating a highly accurate discriminative model using the domain adaptation even in a case where the number of samples of a part of classes of the source domain is small.

### Means for Solving the Problem

According to an example aspect of the present disclosure, there is provided a learning device including:
a feature extraction means configured to extract image features from an input image;
a class discrimination means configured to discriminate a class of the input image based on the image features, and generate a class discriminative result;
a class discriminative loss calculation means configured to calculate a class discriminative loss based on the class discriminative result;
a normal/abnormal discrimination means configured to discriminate whether the class is a normal class or an abnormal class based on the image features, and generate a normal/abnormal discriminative result;
an AUC loss calculation means configured to calculate an AUC loss based on the normal/abnormal discriminative result;
a first learning means configured to update parameters of the feature extraction means, the class discrimination means, and the normal/abnormal discrimination means based on the class discriminative loss and the AUC loss;
a domain discrimination means configured to discriminate a domain of the input image based on the image features and generate a domain discriminative result;
a domain discriminative loss calculation means configured to calculate a domain discriminative loss based on the domain discriminative result; and
a second learning means configured to update parameters of the feature extraction means and the domain discrimination means based on the domain discriminative loss.

According to another example aspect of the present disclosure, there is provided a trained model generation method, including:
extracting image features from an input image by using a feature extraction model;
discriminating a class of the input image by using a class discriminative model based on the image features, and generating a class discriminative result;
calculating a class discriminative loss based on the class discriminative result;
discriminating whether the class is a normal class or an abnormal class by using a normal/abnormal discriminative model based on the image features, and generating a normal/abnormal discriminative result;
calculating an AUC loss based on the normal/abnormal discriminative result;
updating parameters of the feature extraction model, the class discriminative model, and the normal/abnormal discriminative model based on the class discriminative loss and the AUC loss;
discriminating a domain of the input image by using a domain discriminative model based on the image features and generating a domain discriminative result;
calculating a domain discriminative loss based on the domain discriminative result; and
updating parameters of the feature extraction model and the domain discriminative model based on the domain discriminative loss.

According to a further example aspect of the present disclosure, there is provided a recording medium storing a program, the program causing a computer to perform a process including:
extracting image features from an input image by using a feature extraction model;
discriminating a class of the input image by using a class discriminative model based on the image features, and generating a class discriminative result;
calculating a class discriminative loss based on the class discriminative result;
discriminating whether the class is a normal class or an abnormal class by using a normal/abnormal discriminative model based on the image features, and generating a normal/abnormal discriminative result;
calculating an AUC loss based on the normal/abnormal discriminative result;
updating parameters of the feature extraction model, the class discriminative model, and the normal/abnormal discriminative model based on the class discriminative loss and the AUC loss;
discriminating a domain of the input image by using a domain discriminative model based on the image features and generating a domain discriminative result;
calculating a domain discriminative loss based on the domain discriminative result; and
updating parameters of the feature extraction model and the domain discriminative model based on the domain discriminative loss.

### EFFECT OF THE INVENTION

According to the present disclosure, it becomes possible to generate a highly accurate discriminative model using a domain adaptation even in a case where the number of samples of a part of classes of a source domain is small.

### BRIEF DESCRIPTION OF THE DRAWINGS

FIG. 1 illustrates an overall configuration of a learning device according to a first embodiment.

FIG. 2 is a block diagram illustrating a hardware configuration of the learning device.

FIG. 3 is a block diagram illustrating a functional configuration of the learning device.

FIG. 4 illustrates a configuration example of a normal/abnormal discrimination unit.

FIG. 5 is a diagram for explaining an example of an operation of the normal/abnormal discrimination unit.

FIG. 6 is a flowchart of a discriminative model generation process performed by the learning device.

FIG. 7 is a block diagram illustrating a functional configuration of a learning device according to a second example embodiment.

### EXAMPLE EMBODIMENTS

In the following, example embodiments will be described with reference to the accompanying drawings.

### First Example Embodiment

First, a learning device according to a first example embodiment will be described.

### Overall Configuration

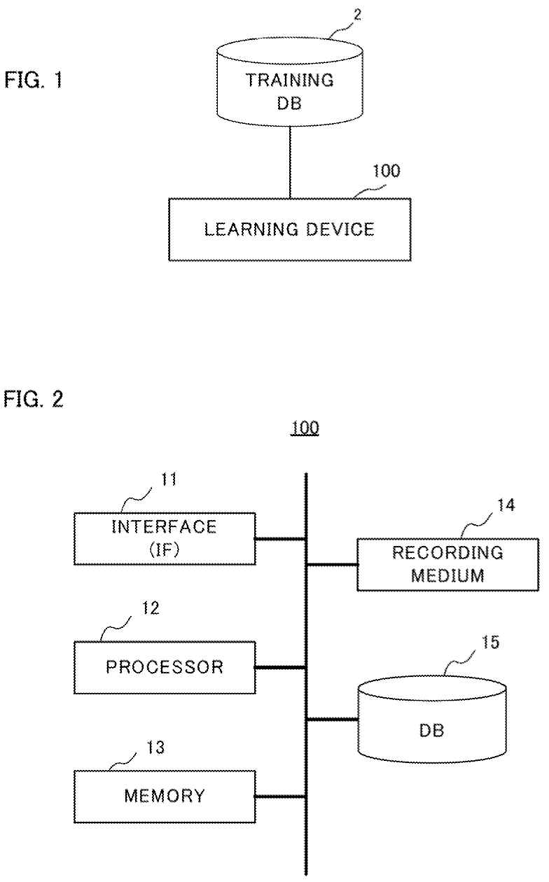

FIG. 1 illustrates an overall configuration of the learning device according to the first example embodiment. The learning device 100 trains a discriminative model used in a target domain using a domain adaptation. The learning device 100 is connected to a training database (hereinafter, a “database” is referred to as a “DB”). The training DB 2 stores the training data used to train the discriminative model.

### Training Data

The training data are data prepared in advance for training the discriminative model, and form a pair of an input image and a correct label thereon. The “input image” is an image obtained in a source domain or the target domain. The “correct label” is a label indicating a correct answer for the input image. In the present example embodiment, the correct label includes a correct class label, a correct normal/abnormal label, and a correct domain label.

Specifically, the correct class label and the correct normal/abnormal label are prepared for the input image obtained from the source domain. The “correct class label” is a label which indicates a correct answer with respect to a class discriminative result by the discriminative model, that is, the correct answer of the class such as an object or the like appeared in the input image. The “correct normal/abnormal answer label” is a label which indicates a correct answer whether a class such as an object appeared in the input image is a normal class or an abnormal class. Note that each class to be discriminated by the discriminative model is classified in advance into either one of the normal class and the abnormal class, and the correct normal/abnormal label is a label which indicates whether the class of the object appeared in the input image belongs to the normal class or the abnormal class.

Moreover, the correct domain label is provided for the input image obtained from both the source domain and the target domain. The “correct domain label″” is a label which indicates whether the input image is an image obtained in either one of the source domain and the target domain.

Next, examples of domain and the normal/abnormal class will be described. As an example, in a case where the discriminative model to be trained is a product discriminative model which discriminates a product class from a product image, product images collected from a shopping site on the Web may be used as the source domain, and product images handled at a real store may be used as a target domain. In this case, since a product class which is less handled on the Web has a small number of product image samples, the product class can be regarded as the abnormal class. Hence, among a plurality of product classes to be discriminated, the product class which is less handled on the Web is set as the abnormal class, and other product classes are set as normal classes.

As another example, in a case of training the discriminative model which recognizes an object or an event from each captured image of a surveillance camera, a camera A installed at a location can be used as the source domain, and a camera B installed at another location can be used as the target domain. Here, in a case where a particular object or a particular event is rare, a class of the object or the event can be regarded as the abnormal class. For instance, in a case of recognizing a person, rare personal attributes such as firefighters and police officers can be set as the abnormal classes, and other personal attributes can be set as the normal classes.

### Hardware Configuration

FIG. 2 is a block diagram illustrating a hardware configuration of the learning device 100. As illustrated, the learning device 100 includes an interface (hereinafter, referred to as an “IF”) 11, a processor 12, a memory 13, a recording medium 14, and a database (DB) 15).

The IF 11 inputs and outputs data from and to an external device. Specifically, the training data stored in the training DB 2 are input to the learning device 100 via the IF 11.

The processor 12 is a computer such as a CPU (Central Processing Unit) and controls the entire learning device 100 by executing programs prepared in advance. Specifically, the processor 12 executes a discriminative model generation process which will be described later.

The memory 13 is formed by a ROM (Read Only Memory), a RAM (Random Access Memory), or the like. The memory 13 is also used as a working memory during executions of various processes by the processor 12.

The recording medium 14 is a non-volatile and non-transitory recording medium such as a disk-shaped recording medium, a semiconductor memory, or the like, and is formed to be detachable from the learning device 100. The recording medium 14 records various programs executed by the processor 12. When the learning device 100 executes various kinds of processes, the programs recorded on the recording medium 14 are loaded into the memory 13 and executed by the processor 12.

The database 15 temporarily stores the training data input through the IF 11. The database 15 stores parameters for neural networks or the like which constitutes respective discriminative models of description units, which will be described later, in the learning device 100. Note that the learning device 100 may include an input unit such as a keyboard, a mouse, or the like, and a display unit such as a liquid crystal display for a user to make instructions and input data.

### Function Configuration

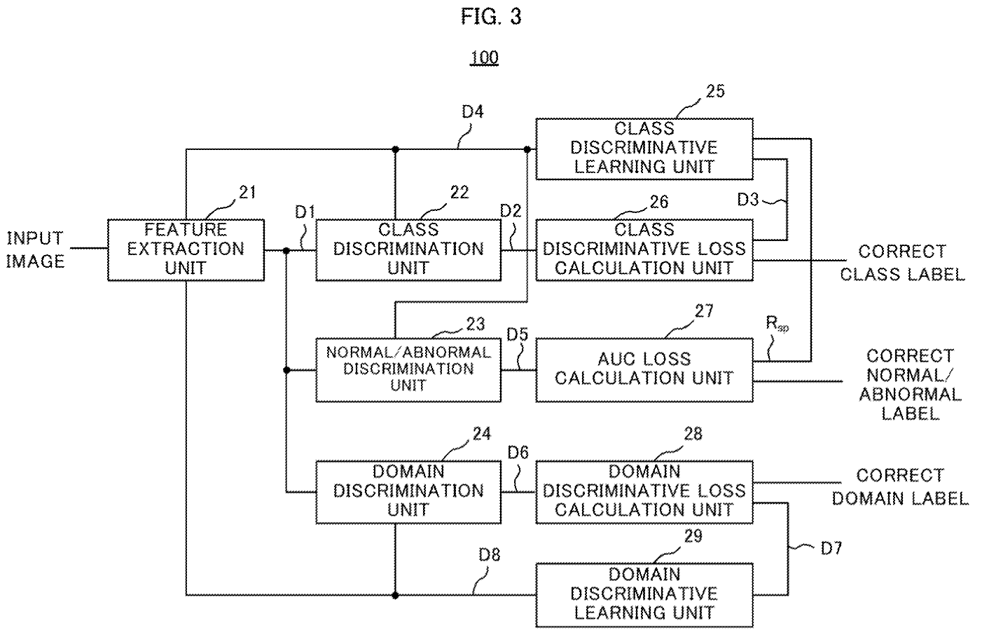

FIG. 3 is a block diagram illustrating a functional configuration of the learning device 100. As illustrated, the learning device 100 includes a feature extraction unit 21, a class discrimination unit 22, a normal/abnormal discrimination unit 23, a domain discrimination unit 24, a class discriminative learning unit 25, a class discriminative loss calculation unit 26, an AUC (Area Under an ROC Curve) loss calculation unit 27, a domain discriminative loss calculation unit 28, and a domain discriminative learning unit 29.

Each input image of the training data is input to the feature extraction unit 21. The feature extraction unit 21 extracts image features D1 by a CNN (Convolutional Neural Network) or another method from each input image, and outputs the extracted image features D1 to the class discrimination unit 22, the normal/abnormal discrimination unit 23, and the domain discrimination unit 24.

The class discrimination unit 22 discriminates a class of each input image based on the image features D1, and outputs a class discriminative result D2 to the class discriminative loss calculation unit 26. The class discrimination unit 22 discriminates a class of each input image using a class discriminative model which uses various machine learning techniques, neural networks, and the like. The class discriminative result D2 includes a reliability score for each class to be discriminated.

The class discriminative loss calculation unit 26 calculates a class discriminative loss D3 using the class discriminative result D2 and the correct class label for each of input images included in the training data, and outputs the class discriminative loss D3 to the class discriminative learning unit 25. The class discriminative loss calculation unit 26 calculates a loss such as, for instance, a cross entropy using the class discriminative result D2 and the correct class label, and outputs the loss as the class discriminative loss D3 to the class discriminative learning unit 25.

Based on the image features D1, the normal/abnormal discrimination unit 23 generates a normal/abnormal discriminative result D5 which indicates whether the input image corresponds to the normal class or the abnormal class, and outputs the normal/abnormal discriminative result D5 to the AUC loss calculation unit 27. Specifically, the normal/abnormal discrimination unit 23 calculates a normal/abnormal score g_{P}(x) which indicates a normal class likelihood by the following formula for each sample x of the input image, and outputs the calculated score as the normal/abnormal discriminative result D5.

$${g}_{P} \left(x\right) = {\sum }_{i ∈ P} \hat{p} \left(i \left|x\right)\right)$$

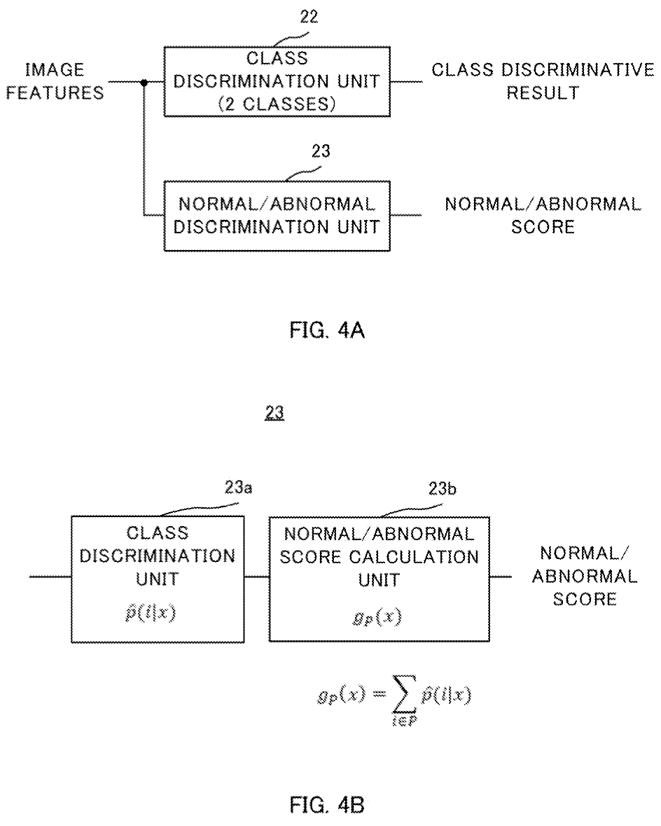

FIG. 4A illustrates an example of a configuration of the normal/abnormal discrimination unit 23. The example in FIG. 4A represents a case in which the class discrimination unit 22 performs a two-class discrimination. For instance, it is assumed that the class discrimination unit 22 discriminates whether the input image corresponds to a class X or a class Y. Here, it is assumed that the class X is the normal class and the class Y is the anomalous class. In this case, a discriminative model sharing parameters with the class discrimination unit 22 can be used as the normal/abnormal discrimination unit 23. For instance, it is assumed that, for a certain input image, the class discrimination unit 22 outputs a class discriminative result indicating “the reliability score of the class X = 0.8 and the reliability score of the class Y = 0.2”. In this case, since the class X is the normal class, a score for the normal class likelihood of the input image is “0.8”, which is the same as the reliability score for the class X. That is, the normal/abnormal discrimination unit 23 may calculate the normal/abnormal score indicating the normal class likelihood using the same discriminative model as the class discrimination unit 22, and may output the normal/abnormal discriminative result D5.

FIG. 4B illustrates another example of the configuration of the normal/abnormal discrimination unit 23. The example in FIG. 4B represents a case in which the class discrimination unit 22 performs multi-class discrimination for three or more classes. In this case, the normal/abnormal discrimination unit 23 includes a class discrimination unit 23a which performs the multi-class discrimination, and a normal/abnormal score calculation unit 23b. Note that the class discrimination unit 23a may have the same configuration as the class discrimination unit 22. The class discrimination unit 23a calculates a reliability score p^ (i|x) for each sample x of the input image, and outputs the calculated score to the normal/abnormal score calculation unit 23b. Based on the input reliability score p^ (i|x), the normal/abnormal score calculation unit 23b calculates a normal/abnormal score g_{P}(x) indicating the normal class likelihood for each sample x of the input image, and outputs the calculated score as the normal/abnormal discriminative result D5.

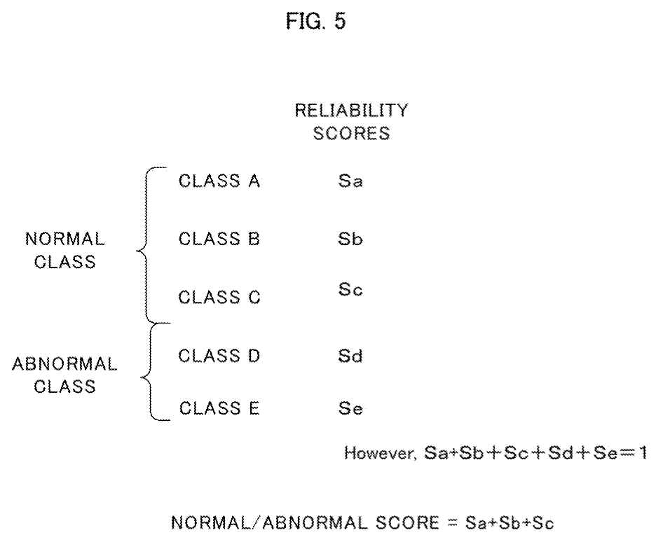

FIG. 5 is a diagram illustrating an example of an operation of the normal/abnormal discrimination unit 23 depicted in FIG. 4B. Assumed that the class discrimination unit 23a discriminates five classes of classes A to E. In addition, among these five classes, the classes A to C are the normal classes and the classes D to E are the abnormal classes. The class discrimination unit 23a discriminates each class of the input images, calculates the reliability scores Sa to Se respective to classes, and outputs the calculated reliability scores to the normal/abnormal score calculation unit 23b. Note that a sum of all classes is 1 for the reliability scores respective to classes for an input image x. That is, an the following equation is represented:

$$\text{Sa+Sb+Sc+Sd+Se = 1} \text{.}$$

The normal/abnormal score calculation unit 23b calculates the score of the normal class likelihood of the input image based on the input reliability scores respective to the classes. Specifically, the normal/abnormal score calculation unit 23b sums the reliability scores of the classes A to C, which are the normal classes, and calculates the normal/abnormal score as follows,

$$\text{Normal/abnormal score} = \text{Sa+Sb+Sc} \text{.}$$

After that, the normal/abnormal score calculation unit 23b outputs the obtained normal/abnormal score as the normal/abnormal discriminative result D5. Accordingly, in the example in FIG. 4B, it is possible to calculate the normal/abnormal discriminative result even in a case where the class discrimination unit 22 performs the multi-class discrimination.

Returning to FIG. 3, the AUC loss calculation unit 27 calculates the AUC loss based on the normal/abnormal discriminative result D5 and the correct normal/abnormal label included in the training data. Specifically, the AUC loss calculation unit 27 first acquires the correct normal/abnormal label for each sample x of the input image, and classifies each sample x into the normal class and the abnormal class. Next, the AUC loss calculation unit 27 extracts a sample x^{N} of the normal class and a sample x^{P} of the abnormal class, and makes a pair of these samples. Next, the AUC loss calculation unit 27 calculates an AUC loss Rₛₚ by using a difference between a normal/abnormal score gₚ(x^{N}) of the sample x^{N} and a normal/abnormal score g_{P}(x^{P}) of the sample x^{P} in accordance with the following equation, and outputs the AUC loss Rₛₚ to the class discriminative learning unit 25.

$${R}_{s p} = {p}_{} \left[{N}_{} \left[l \left({g}_{p} \left({x}^{P}\right) - {g}_{P} \left({x}^{N}\right)\right)\right]\right]$$

In the above equation, “1 (el)” denotes a monotonically decreasing function taking a value of 0 or more, such as the following sigmoid function is used as an example.

$$l \left(z\right) = \text{sigmoid} \left(- z\right)$$

The class discriminative learning unit 25 updates parameters of a model forming the feature extraction unit 21, the class discrimination unit 22, and the normal/abnormal discrimination unit 23 by a control signal D4 based on the class discriminative loss D3 and the AUC loss Rₛₚ. Specifically, the class discriminative learning unit 25 updates parameters of the feature extraction unit 21, the class discrimination unit 22, and the normal/abnormal discrimination unit 23, so that the class discriminative loss D3 becomes smaller and the AUC loss Rₛₚ becomes smaller.

The domain discrimination unit 24 discriminates a domain of the input image based on the image features D1, and outputs a domain discriminative result D6 to the domain discriminative loss calculation unit 28. The domain discriminative result D6 indicates a score which represents a source domain likelihood or a target domain likelihood of the input image. The domain discriminative loss calculation unit 28 calculates a domain discriminative loss D7 based on the domain discriminative result D6 and the correct domain label of the input image included in the training data, and outputs the calculated loss to the domain discriminative learning unit 29.

The domain discriminative learning unit 29 updates parameters of the feature extraction unit 21 and the domain discrimination unit 24 by a control signal D8 based on the domain discriminative loss D7. Specifically, the domain discriminative learning unit 29 extracts the image features D1 that makes it difficult for the feature extraction unit 21 to discriminate the domain, and updates the parameters of the feature extraction unit 21 and the domain discrimination unit 24 so that the domain discrimination unit 24 can correctly discriminate the domain.

As described above, in the present example embodiment, in the learning of the class discriminative model using the domain adaptation, the parameters of the feature extraction unit 21, the class discrimination unit 22, and the normal/abnormal discrimination unit 23 are updated using the AUC loss Rₛₚ, so that the adverse effects caused by the imbalance among numbers of samples for respective classes of the input image can be suppressed. Therefore, even in a case where there are few input images of a particular abnormal class, it is possible to generate a class discriminative model capable of highly accurate discrimination.

### Discriminative Model Generation Process

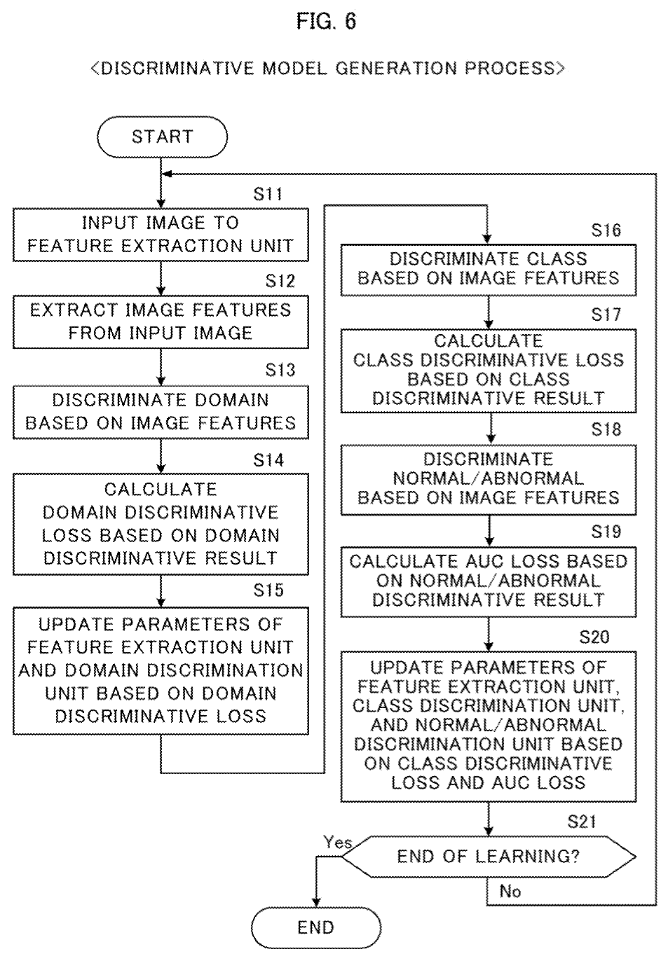

FIG. 6 is a flowchart of the discriminative model generation process performed by the learning device 100. This process is realized by the processor 12 depicted in FIG. 2, which executes a program prepared in advance and operates as each element depicted in FIG. 3.

First, the input image included in the training data is input to the feature extraction unit 21 (step S11), and the feature extraction unit 21 extracts the image features D1 from the input image (step S12). Next, the domain discrimination unit 24 discriminates a domain based on the image features D1, and outputs the domain discriminative result D6 (step S13). After that, the domain discriminative loss calculation unit 28 calculates the domain discriminative loss D7 based on the domain discriminative result D6 and the correct domain label (step S14). Subsequently, the domain discriminative learning unit 29 updates the parameters of the feature extraction unit 21 and the domain discrimination unit 24 based on the domain discriminative loss D7 (step S15). Note that steps S13 to S15 are referred to as a “domain mixing process”.

Next, the class discrimination unit 22 discriminates a class of the input image based on the image features D1, and generates the class discriminative result D2 (step S16). Next, the class discriminative loss calculation unit 26 calculates the class discriminative loss D3 using the class discriminative result D2 and the correct class label (step S17). Note that steps S16 to S17 are referred to as a “class discriminative loss calculation process”.

Next, based on the image features D1, the normal/abnormal discrimination unit 23 discriminates whether the input image is a normal class or an abnormal class, and outputs the normal/abnormal discriminative result D5 (step S18). After that, the AUC loss calculation unit 27 calculates the AUC loss Rₛₚ based on the normal/abnormal discriminative result D5 (step S19). Note that steps S18 to S19 are referred to as an “AUC loss calculation process”.

Subsequently, the class discriminative learning unit 25 updates parameters of the feature extraction unit 21, the class discrimination unit 22, and the normal/abnormal discrimination unit 23 based on the class discriminative loss D3 and the AUC loss Rₛₚ (step S20). Note that steps S16 to S20 are called a “class discriminative learning process”.

Next, the learning device 100 determines whether or not to terminate the learning (step S21). When the class discriminative loss, the AUC loss, and the domain discriminative loss converge to respective predetermined ranges, the learning device 100 determines that the learning is completed. When learning is not completed (step S21: No), the learning device 100 goes back to step S11 and repeats processes of step S11 to S20 using another input image. On the other hand, when the learning is completed (step S21: Yes), the discriminative model generation process is terminated.

In the above-described example embodiment, the class discriminative learning process (steps S16 to S20) is performed after the domain mixing process (steps S13 to S15), but an order of the domain mixing process and the class discriminative learning process may be reversed. In the above example, the AUC loss calculation process (steps S18 to 19) is performed after the class discriminative loss calculation process (steps S16 to S17), but the order of the class discriminative loss calculation process and the AUC loss calculation process may be reversed.

Furthermore, in the above example, the parameter update is performed based on the class discriminative loss and the AUC loss in step S20, but instead, the parameter update may be performed based on the AUC loss in step S17 by providing a step of updating the parameters based on the class discriminative loss.

### Second Example Embodiment

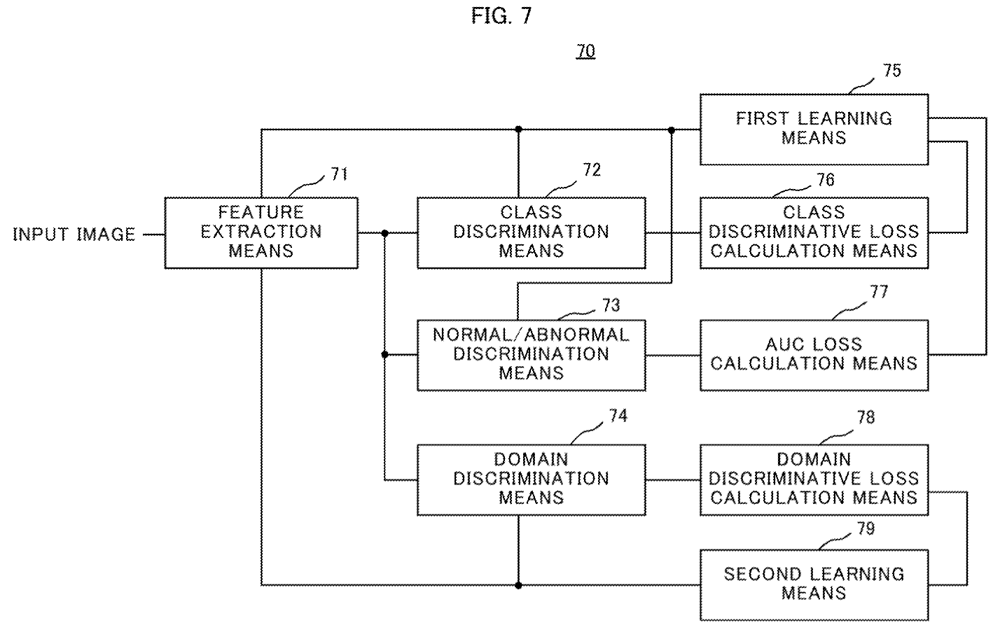

Next, a second example embodiment of the present invention will be described. FIG. 7 is a block diagram illustrating a functional configuration of a learning device 70 according to the second example embodiment. As illustrated, the learning device 70 includes a feature extraction means 71, a class discrimination means 72, a normal/abnormal discrimination means 73, a domain discrimination means 74, a first learning means 75, a class discriminative loss calculation means 76, an AUC loss calculation means 77, a domain discriminative loss calculation means 78, and a second learning means 79.

The feature extraction means 71 extracts image features from the input image. The class discrimination means 72 discriminates the class of the input image based on the image features and generates a class discriminative result. The class discriminative loss calculation means 76 calculates a class discriminative loss based on the class discriminative result. Based on the image features, the normal/abnormal discrimination means 73 discriminates whether the class is the normal class or the abnormal class, and generates a normal/abnormal discriminative result. The AUC loss calculation means 77 calculates an AUC loss based on the normal/abnormal discriminative result. The first learning means 75 updates parameters of the feature extraction means, the class discrimination means, and the normal/abnormal discrimination means based on the class discriminative loss and the AUC loss.

The domain discrimination means 74 discriminates a domain of the input image based on the image features, and generates the domain discriminative result. The domain discriminative loss calculation means 78 calculates the domain discriminative loss based on the domain discriminative result. The second learning means 79 updates parameters of the feature extraction means and the domain discrimination means based on the domain discriminative loss.

A part or all of the example embodiments described above may also be described as the following supplementary notes, but not limited thereto.

### Supplementary Note 1

1. A learning device comprising:
a feature extraction means configured to extract image features from an input image;
a class discrimination means configured to discriminate a class of the input image based on the image features, and generate a class discriminative result;
a class discriminative loss calculation means configured to calculate a class discriminative loss based on the class discriminative result;
a normal/abnormal discrimination means configured to discriminate whether the class is a normal class or an abnormal class based on the image features, and generate a normal/abnormal discriminative result;
an AUC loss calculation means configured to calculate an AUC loss based on the normal/abnormal discriminative result;
a first learning means configured to update parameters of the feature extraction means, the class discrimination means, and the normal/abnormal discrimination means based on the class discriminative loss and the AUC loss;
a domain discrimination means configured to discriminate a domain of the input image based on the image features and generate a domain discriminative result;
a domain discriminative loss calculation means configured to calculate a domain discriminative loss based on the domain discriminative result; and
a second learning means configured to update parameters of the feature extraction means and the domain discrimination means based on the domain discriminative loss.

### Supplementary Note 2

2. The learning device according to claim 1, wherein
the class discrimination means classifies the input image into two classes, and
the normal/abnormal discrimination means includes the same parameters as that of the class discrimination means.

### Supplementary Note 3

3. The learning device according to claim 1, wherein
the class discrimination means classifies the input image into three or more classes, and
the normal/abnormal discrimination means classifies the input image into the three classes, calculates class discriminative scores respective to the three classes, and generates the normal/abnormal discriminative result indicating a normal class likelihood by using a class discriminative score of the normal class and a class discriminative score of the abnormal class.

### Supplementary Note 4

4. The learning device according to any one of claims 1 to 3, wherein
the normal/abnormal discriminative result indicates a normal class likelihood for each input image, and
the AUC loss calculation means calculates, as the AUC loss, a difference between the normal/abnormal discriminative result calculated for an input image of the normal class and the normal/abnormal discriminative result calculated for an input image of the abnormal class, by using correct normal/abnormal labels indicating respective input images.

### Supplementary Note 5

5. The learning device according to claim 4, wherein the first learning means updates parameters of the feature extraction means, the class discrimination means, and the normal/abnormal discrimination means so as to reduce the AUC loss.

### Supplementary Note 6

6. A trained model generation method, comprising:
extracting image features from an input image by using a feature extraction model;
discriminating a class of the input image by using a class discriminative model based on the image features, and generating a class discriminative result;
calculating a class discriminative loss based on the class discriminative result;
discriminating whether the class is a normal class or an abnormal class by using a normal/abnormal discriminative model based on the image features, and generating a normal/abnormal discriminative result;
calculating an AUC loss based on the normal/abnormal discriminative result;
updating parameters of the feature extraction model, the class discriminative model, and the normal/abnormal discriminative model based on the class discriminative loss and the AUC loss;
discriminating a domain of the input image by using a domain discriminative model based on the image features and generating a domain discriminative result;
calculating a domain discriminative loss based on the domain discriminative result; and
updating parameters of the feature extraction model and the domain discriminative model based on the domain discriminative loss.

### Supplementary Note 7

7. A recording medium storing a program, the program causing a computer to perform a process comprising:
extracting image features from an input image by using a feature extraction model;
discriminating a class of the input image by using a class discriminative model based on the image features, and generating a class discriminative result;
calculating a class discriminative loss based on the class discriminative result;
discriminating whether the class is a normal class or an abnormal class by using a normal/abnormal discriminative model based on the image features, and generating a normal/abnormal discriminative result;
calculating an AUC loss based on the normal/abnormal discriminative result;
updating parameters of the feature extraction model, the class discriminative model, and the normal/abnormal discriminative model based on the class discriminative loss and the AUC loss;
discriminating a domain of the input image by using a domain discriminative model based on the image features and generating a domain discriminative result;
calculating a domain discriminative loss based on the domain discriminative result; and
updating parameters of the feature extraction model and the domain discriminative model based on the domain discriminative loss.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

DESCRIPTION OF SYMBOLS

| | |
|---|---|
| 2 | Training database |
| 21 | Feature extraction unit |
| 22 | Class discrimination unit |
| 23 | Normal/abnormal discrimination unit |
| 24 | Domain discrimination unit |
| 25 | Class discriminative learning unit |
| 26 | Class discriminative loss calculation unit |
| 27 | AUC loss calculation unit |
| 28 | Domain discriminative loss calculation unit |
| 29 | Domain discriminative learning unit |
| 100 | Learning device |

What is claimed is:

1. A learning device comprising:
a memory storing instructions; and
one or more processors configured to execute the instructions to:
extract image features from an input image by using a feature extraction model;
discriminate a class of the input image based on the image features, and generate a class discriminative result by using a class discriminative model;
calculate a class discriminative loss based on the class discriminative result;
discriminate whether the class is a normal class or an abnormal class by using a normal/abnormal discriminative model based on the image features, and generate a normal/abnormal discriminative result;
calculate an AUC loss based on the normal/abnormal discriminative result;
update parameters of the feature extraction model, the class discriminative model, and the normal/abnormal discriminative model based on the class discriminative loss and the AUC loss;
discriminate a domain of the input image based on the image features and generate a domain discriminative result;
calculate a domain discriminative loss based on the domain discriminative result; and
update parameters of the feature extraction model and the domain discriminative model based on the domain discriminative loss.

2. The learning device according to claim 1, wherein
the class discriminative model classifies the input image into two classes, and
the normal/abnormal discriminative model includes the same parameters as that of the class discriminative model.

3. The learning device according to claim 1, wherein
the class discriminative model classifies the input image into three or more classes, and
the normal/abnormal discriminative model classifies the input image into the three classes, calculates class discriminative scores respective to the three classes, and generates a normal/abnormal discriminative result indicating a normal class likelihood by using a class discriminative score of the normal class and a class discriminative score of the abnormal class.

4. The learning device according to claim 1, wherein
the normal/abnormal discriminative result indicates a normal class likelihood for each input image, and
the processor calculates, as the AUC loss, a difference between a normal/abnormal discriminative result calculated for an input image of the normal class and a normal/abnormal discriminative result calculated for an input image of the abnormal class, by using correct normal/abnormal labels indicating respective input images.

5. The learning device according to claim 4, wherein the processor updates parameters of the feature extraction model, the class discriminative model, and the normal/abnormal discriminative model so as to reduce the AUC loss.

6. A trained model generation method, comprising:
extracting image features from an input image by using a feature extraction model;
discriminating a class of the input image by using a class discriminative model based on the image features, and generating a class discriminative result;
calculating a class discriminative loss based on the class discriminative result;
discriminating whether the class is a normal class or an abnormal class by using a normal/abnormal discriminative model based on the image features, and generating a normal/abnormal discriminative result;
calculating an AUC loss based on the normal/abnormal discriminative result;
updating parameters of the feature extraction model, the class discriminative model, and the normal/abnormal discriminative model based on the class discriminative loss and the AUC loss;
discriminating a domain of the input image by using a domain discriminative model based on the image features and generating a domain discriminative result;
calculating a domain discriminative loss based on the domain discriminative result; and
updating parameters of the feature extraction model and the domain discriminative model based on the domain discriminative loss.

7. A non-transitory computer-readable recording medium storing a program, the program causing a computer to perform a process comprising:
extracting image features from an input image by using a feature extraction model;
discriminating a class of the input image by using a class discriminative model based on the image features, and generating a class discriminative result;
calculating a class discriminative loss based on the class discriminative result;
discriminating whether the class is a normal class or an abnormal class by using a normal/abnormal discriminative model based on the image features, and generating a normal/abnormal discriminative result;
calculating an AUC loss based on the normal/abnormal discriminative result;
updating parameters of the feature extraction model, the class discriminative model, and the normal/abnormal discriminative model based on the class discriminative loss and the AUC loss;
discriminating a domain of the input image by using a domain discriminative model based on the image features and generating a domain discriminative result;
calculating a domain discriminative loss based on the domain discriminative result; and
updating parameters of the feature extraction model and the domain discriminative model based on the domain discriminative loss.
